(19) United States
(12) Patent Application Publication
(10) Pub. No.: US 2010/0122215 A1
(43) Pub. Date: May 13, 2010

(54) CONTROL INTERFACE FOR HOME AUTOMATION SYSTEM

(75) Inventor: Christopher P. L. MacGregor, Seabrook, TX (US)

Correspondence Address: FULBRIGHT & JAWORSKI, LLP, 1301 MCKINNEY, SUITE 5100, HOUSTON, TX, 77010-3095, US

(73) Assignee: QWEBL, Inc.

(21) Appl. No.: 12/616,256

(22) Filed: Nov. 11, 2009

Related U.S. Application Data
(60) Provisional application No. 61/113,396, filed on Nov. 11, 2008.

(51) Int. Cl. G06F 3/048

(52) U.S. Cl. 715/834; 715/841

(57) ABSTRACT

The control interface is adapted for display on a control point for a home automation device and includes a plurality of control buttons, that when selected, invoke services of devices in a home automation network. The control buttons are displayed in a selection wheel, which is preferably implemented in a circular, double linked list data structure. The control interface includes a horizon that extends along the horizontal axis of the display screen and is vertically centered. The user's focal point, preferably colored differently than other elements on the display, remains centered on the horizon as the user scrolls from one control button in the selection wheel to another. Choosing a control button on a first selection wheel results in display of a second adjacent selection wheel.

### RELATED APPLICATION

This Application claims the benefit of U.S. Provisional Application No. 61/113,396 filed on Nov. 11, 2008, the contents of which are hereby incorporated by reference in their entirety.

### TECHNICAL FIELD

The disclosed embodiments relate generally to graphical user interfaces, and more particularly, but not by way of limitation, to user control interfaces for home automation systems in the field of domotics.

### BACKGROUND

Home automation systems provide for deployment of home monitoring technology for automatically switching devices on/off, dimming lights, reading thermostats, and controlling the services of any other device/appliance in the home that is networked with a master control system. The master control system includes a dedicated processor, on a computer or dedicated hardware device, that is controlled by a control point. The control point may be a wall-mounted touch panel, an Internet-enabled mobile device, such as a laptop, mobile telephone, smart phone, PDA, etc., or any other communications device. Control points include a user interface for users to invoke devices services, configure device settings, and otherwise control device operations. A problem is that existing user interfaces, especially graphical user interfaces implemented on computers and mobile control points, are poorly designed and difficult to navigate, resulting in an unpleasant user experience and inefficient use of the user's time. Another problem is that existing user interfaces fail to efficiently display relevant options, past selections, and current device settings. Yet another problem is that existing interfaces do not employ a consistent focus method making them difficult to interpret, find focus, and navigate.

### BRIEF SUMMARY

The disclosed embodiments overcome the above and other limitations by providing a control interface that enables an easy to use and efficient graphical display. The disclosed embodiments also provide a vertical and horizontal axis to differentiate between commands and selections; such that vertical choices are brought to the horizontal command axis to be invoked. Users interact with a control point's control interface to setup/edit controls and invoke operations of devices in the home network. The control interface displays control buttons for the devices in a home network. When activated, control buttons cause command and control messages to be sent and received from devices, thus invoking device services, identifying rooms, and otherwise controlling device settings and presettings (e.g., on/off, power percentage, volume, temperature).

In the preferred embodiment, the control interface includes a focal point representing the user's current position on the graphical display. The focal point is preferably centered on the horizon, which extends horizontally across the display screen. The control interface also preferably includes one or more selection wheels with one or more control buttons. The user expresses choices on the system by selecting control buttons on a selection wheel. In one embodiment, the user's current preferred control button—the focal point—remains centered on the display screen as the user scrolls from one control button to another. The selection wheel is preferably implemented as a double circular linked list, and thus, when scrolling, the user does not encounter a head or a tail control button. In another embodiment, choosing a control button on a first selection wheel results in display of a second adjacent selection wheel. Yet another embodiment includes a nudge control which adjusts the value within the control when activated by the user. As the user navigates, the system selectively applies a plurality of shading, shadowing, and/or coloring schemes for ease of use and improved aesthetics. Such schemes may incorporate the focal point, horizon, selection wheel(s), control button(s), (each, a “display element”) and/or other features of the display to indicate selections the user has already made or may make with further navigation.

In further embodiments, a control interface for the home automation system includes a selection wheel adapted for display on the control interface. The selection wheel includes a plurality of control buttons for controlling devices in the home automation system. A data structure is employed for linking the selection wheel's control buttons in a continuous ring, so that a complete unidirectional traversal on the selection wheel returns to the control button where the traversal started. Optionally, the selection wheel's control buttons represents a user's current preference and is displayed as a focal point with a different shape and/or shading than other control buttons in the selection wheel. For a given control button x in the selection wheel, the data structure may further comprise a first pointer for indicating the control button x's successor control button, and a second pointer for indicating the control button x's predecessor control button. The first pointer, if control button x is a head control button, indicates a tail control button in the selection wheel. The second pointer, if control button x is the tail control button, indicates the head control button in the selection wheel. The control interface may further comprise a second selection wheel displayable in a position adjacent to the first selection wheel.

Alternatively, the control interface apparatus of the home automation system comprises a horizon extending from a first edge of the control interface to a second opposite edge, and at least one focal point for tracking a control button to display along the horizon. The focal point changes from one control button to another as the user navigates the home automation system. Optionally, the horizon has a horizontal longitudinal axis that is centered vertically on the control interface. The focal point tracks the control button under the user's control that, when selected, invokes services on at least one device in the home automation system.

Alternatively, the control interface includes a first selection wheel having a plurality of control buttons displayable as a continuous ring on a control interface. The first selection wheel's control buttons are adapted to for controlling devices in a home automation network. The control interface also includes at least one horizon on the control interface extending from a first edge of the user interface to a second opposite edge. The horizon provides a centering point for at least one of first selection wheel's control buttons. Optionally, the control interface employs a data structure for linking the selection wheel's control buttons so that a complete unidirectional traversal on the first selection wheel returns to the control button where the traversal started. A focal point may be employed for tracking the control button currently under the user's control, such that the focal point is displayed along the at least one horizon. The control interface may also include a second selection wheel. In this embodiment, the first and second selection wheels are displayed adjacent to one another on the control interface. The control interface of may include crumb trail representing at least one control button previously selected by the user. A control button previously selected on the first selection wheel has a different color than the control buttons of the first selection wheel.

The preferred method for controlling operations of a home automation system includes displaying a first selection wheel on a control interface of a home automation system. The first selection wheel includes a plurality of control buttons for controlling devices in the home automation system. The method further includes linking the first selection wheel's control buttons in a data structure so that a complete unidirectional traversal on the first selection wheel returns to the control button where the traversal began. Optionally, the step of displaying a first selection wheel also includes centering a control button representing the control button currently under the user's control along a horizon. The method may also include shaping or coloring the focal point differently than the other elements on a display screen. Optionally, for a given control button x in the first selection wheel, the step of linking the selection wheel's control buttons in a data structure further comprises the steps of indicating the control button x's successor control button with a first pointer, and indicating the control button x's predecessor control button with a second pointer. Here, the first pointer, if control button x is a head control button, indicates a tail control button in the selection wheel, and the second pointer, if control button x is the tail control button, indicates the head control button in the selection wheel. A second selection wheel may be displayed in a position adjacent to the first selection wheel.

An alternative method for displaying a control interface on a control point for a home automation system includes highlighting a portion of the control interface to form a horizon that extends from a first edge of the control interface to a second opposite edge, tracking a user's current preference on the control interface with at least one focal point as the user navigates the home automation system, and displaying the focal point along the horizon. Highlighting may includes displaying the horizon along the longitudinal axis of the control interface, and centering the horizon vertically on the control interface. Displaying may include centering and re-centering focal point on the horizon as the user navigates. Displaying may include coloring the focal point differently than other elements on the control interface.

Yet another method for displaying a control interface on a control point for a home automation system includes providing at least one selectable control button positioned along a vertical access of a display screen on a control point, and providing at least one command control button for invoking services of a device in a home automation system. Here, the command control button is centered and displayed on the horizontal access of the display screen on a control point, and one or both of the selectable control button and/or command control button are displayed as part of a selection wheel.

The foregoing has outlined rather broadly the features and technical advantages of the disclosed embodiments in order that the detailed description that follows may be better understood. Additional features and advantages of the disclosed embodiments will be described hereinafter which in addition to the above form the subject of the claims of the disclosed embodiments. It should be appreciated that the conception and specific embodiments disclosed may be readily utilized as a basis for modifying or designing other structures for carrying out the same purposes of the disclosed embodiments. It should also be realized that such equivalent constructions do not depart from the disclosed embodiments as set forth in the appended claims. The novel features which are believed to be characteristic of the disclosed embodiments, both as to its organization and method of operation, together with further objects and advantages will be better understood from the following description when considered in connection with the accompanying figures. It is to be expressly understood, however, that each of the figures are provided for the purpose of illustration and description only and are not intended to define of the limits of the disclosed embodiments.

### BRIEF DESCRIPTION OF THE DRAWINGS

FIGS. 1A and 1B show an example device selection wheel, and FIG. 1C shows an example device selection wheel and a room selection wheel;

FIG. 2 shows an example embodiment of the control interface on a display screen;

FIG. 3 shows another example embodiment of the control interface on a display screen;

### DETAILED DESCRIPTION

At least one embodiment of the control interface is implemented in Extensible Markup Language, or another suitable programming language that can be parsed and displayed on a mobile control point (PC, PDA, mobile phone, etc.). In the preferred embodiment, the control point includes a TCP/IP stack that supports one or more communications protocols, web server connectivity, an Extensible Markup Language (“XML”) parser, and support for HyperText Transfer Protocol (“HTTP”). The home automation device may be any suitable hardware device with a processor, such as a computer, that functions as a master controller for a home automation system. Home automation devices designed by Crestron Electronics, Inc. or AMX® are preferred.

Control points send and receive command and control messages with a home automation device, and the home automation device in turn monitors and controls devices such as security systems, multimedia devices, audio systems, lighting, climate controls, and any other system connected to the home automation device. The control points interact with the home automation system in a client-server manner over mobile telephone networks, the Internet, or any other network. The control points preferably function as the client and the home automation device it controls (in response to control point requests) functions as the server, although any other known arrangements are also envisioned. Users express choices on the control interface using touch screen technology, keyboards, mouse, keypads, telephone keypads, or any other input means.

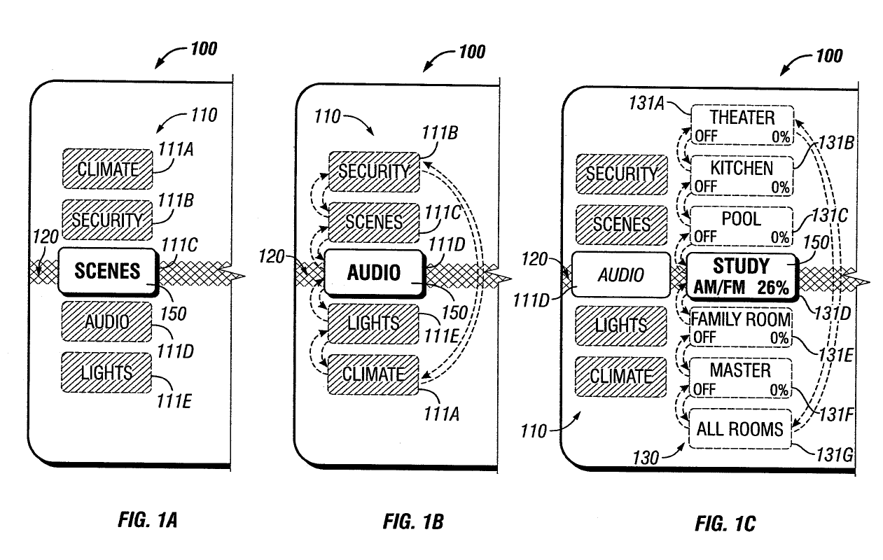

FIGS. 1A, 1B, and 1C show example control interface 100 screens that are displayed to a user on a control point (not shown). Control interface 100 of FIG. 1A includes a device selection wheel 110. The device selection wheel 110 includes a plurality of control buttons for each device/(sub)system/appliance in the home. Selection wheel 110 in FIG. 1 includes control buttons for Climate 111A, Security 111B, Scenes 111C, Audio 111D, and Lights 111E, which represent devices in a user's home. One of ordinary skill in the art will understand that the control interface 100 may include more or fewer control buttons according to the number and type of devices in the user's home automation system.

For easy interpretation by the user, a focal point 150 is provided. The focal point indicates the user's current position of navigation on the display by distinctively identifying the display element under the user's control. The focal point 150 is preferably a control button or a nudge control (described below), but may be any other display element. The focal point 150 preferably displays the element under control in a different color (or shading) than any other element on the display. Alternatively, the focal point 150 displays the element under control to have a different size, shape, font, or another distinctive visual characteristic than other elements. For example, the focal point 150 of FIG. 16. 1A, 1B, and 1C is shown with bold font and a shadow. The focal point 150 is preferably longitudinally centered on the horizon 120 and automatically centers and re-centers as the user navigates (scrolls) up and down. In this way, the user easily understands how to navigate the system and the user's current position within the system.

The horizon 120 is a visible or invisible section that runs horizontally across the display screen. In the preferred embodiment, the focal point 120 is vertically centered on the display screen. Alternatively, the focal point is centered horizontally on the display, or is off center. FIG. 1 shows the Scenes 111C control button as the focal point centered on horizon 120. The focal point 150 has a different shading and is larger in size than the control buttons for other devices (Climate 111A, Security 111B, Audio 111D, and Lights 111E) in the device selection wheel 110, which are grayed out. The device selection wheel 110 is preferably left justified on the display screen 100 to simplify presentation.

Selection wheels are displayed as a ring of control buttons. Selection wheels are preferably implemented as double circular linked lists or, in alternative embodiments, any other type of suitable data structure. In the double circular linked list embodiment, each control button represents a device in the home and includes two pointers: next and previous. For each control button x in the selection wheel, next[x] points to its successor control button in the selection wheel, and previous[x] points to its predecessor. Because the selection wheel is circular, the head control button's previous pointer points to the tail control button in the selection wheel, and the tail control button's next pointer points to the head control button. In this sense, the selection wheel can be seen as having no beginning or ending control button. As a result, a complete traverse of the selection wheel, in any one direction (up/down/side), returns the user to the original control button where the traversal started, thus providing access to all control buttons by unidirectional traversal. The user can repeat the unidirectional traversals, or traverse in the multiple directions to reach the desired control button as desired. This arrangement allows the user to easily view and access all the control buttons in the selection wheel when interacting with the system.

For example, to traverse the device selection wheel in FIG. 1B, the user enters an up/down command on the control point's input means (e.g., keyboard, touch screen, mouse, keypad, etc.). The device selection wheel rolls as the user navigates, such that the focal point 150 (the Audio 111D control button in FIG. 1B) is centered on the horizon 120. The focal point 150 thus tracks the user's preferred control button as the user scrolls on the selection wheel. The focal point 150 is also centered and recentered on horizon 120 after each up/down command as the user enters to navigate the system.

In FIG. 1B for example, assuming the user traverses downward, the control buttons are displayed centered on the horizon 120 in the following sequence: Audio 111D, Lights 111E, Climate 111A, Security 111B, Scenes 111C, Audio 111D (repeat) . . . In an upward traversal of the device selection wheel, the control buttons appear centered on horizon 120 of FIG. 1B in the following sequence: Audio 111D, Scenes 111C, Security 111B, Climate 111A, Lights 111E, Audio 111D (repeat) . . . Note that when the user changes the focal point 150 from the Scenes 111C control button in FIG. 1 to the Audio 111D control button in FIG. 1B, the Climate 111A control button rolls from the top position (FIG. 1A) to the bottom position (FIG. 1B) of the device selection wheel 110. Similarly, the control buttons for Security 111B, Scenes 111D, Audio 111D, Lights 111E devices rotate one position upward from FIG. 1 to FIG. 1B.

When the user selects a control button on a first selection wheel, the system displays a second selection wheel. The second selection wheel (and any additional selection wheels) are preferably displayed in a position adjacent to the selected wheel. Additional selection wheels are preferably implemented as a circular double linked lists or any other data structures, as described above. For example, the control interface shown in FIG. 1C displays a device selection wheel 110 and an adjacent room selection wheel 130. The room selection wheel 130 includes a control button for each room with an audio device (e.g., a speaker) installed in it. As shown in FIG. 1C, room control buttons include: Theater 131A, Kitchen 131D, Pool 131C, Study 131D, Family Room 131E, Master 131 F, and All Rooms 131 G (collectively “131 A-G”), for example. One of ordinary skill in the art will appreciate that more or fewer control buttons may be added to the room selection wheel according to the number of rooms with audio devices (e.g., speaker/tuner) in the user's home. Device status information—on/off, power percentage, etc.—can optionally be displayed on the control buttons as well. For example, FIG. 1C shows Study 131D's control button tuned to an AM/FM radio, with volume at 26% of power. The other audio device of FIG. 1C, located in the following rooms/areas: Theater 131A, Kitchen 131B, Pool 131C, Family Room 131E, and Master 131F, are turned OFF and their volume power is set to 0%. The All Rooms 131G control button, when selected, displays a third selection wheel (not shown) with control buttons for the rooms currently playing an audio source.

As shown in FIG. 1C, the room selection wheel 130 is preferably displayed in a position adjacent to the device selection wheel 110, such that the two wheels are left justified on the display screen 100. Optionally, the adjacent wheels are centered or right justified on the display screen. For readability, the focal point 150 is positioned on horizon 120, which extends horizontally across the display screen in FIG. 1C, to highlight the focal point, which represents the control button (Study 131D) currently under the user's control. Audio 111D control button is also centered on the horizon to identify the user's past selection. The focal point 150 is centered on the horizon 120 as the user scrolls between room control buttons 131A-G. The device selection wheel's 110 control buttons are preferably grayed out to indicate the wheel is not active as the focal point 150 moves along horizon 120 to room selection wheel 130. Alternatively, the system applies different shadings, fonts, and shadowing schemes to the control buttons or other elements to indicate they are active/inactive. The focal point may also have a slightly different shape (e.g. smaller, larger) than control buttons not positioned along the horizon 120 to track the user's history. For example, in FIG. 1C, the focal point is on the Study 131D control button, which appears slightly larger in shape with bold font and a shadow as compared to other control buttons on the room selection wheel 130. Note also that a crumb trail is formed by the previously selected Audio 111D control button which is not shaded and the other control of buttons of device selection wheel 110 are grayed out. Also note that in FIG. 1C the focal point 150 moved to the room selection wheel 130 activating the wheel and making its control buttons (more) visible. These visual schemes provide improved readability, historical tracking, and help orient the user within the system during navigation.

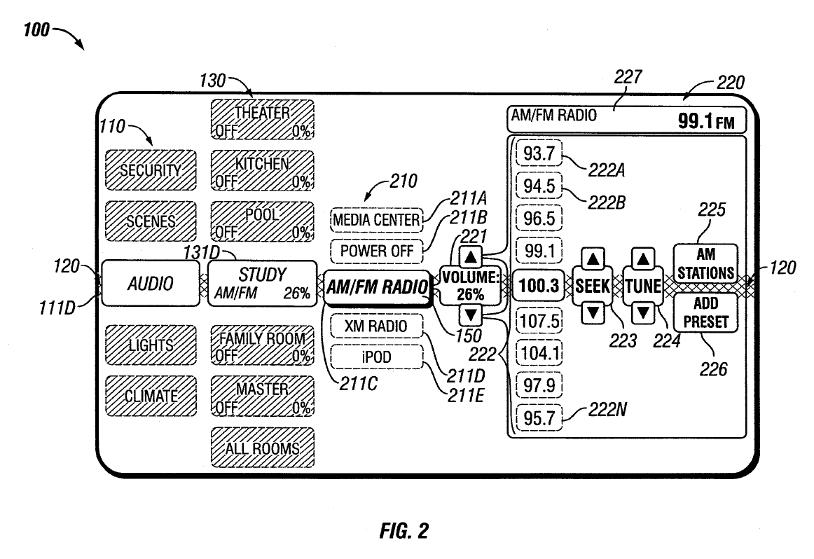

The control interface of FIG. 2 builds upon the control interfaces shown in FIGS. 1A-C by displaying an additional selection wheel—the source selection wheel 210. Source selection wheel 210 includes control buttons for a: Media Center 211A, Power Control 211B (set to OFF), AM/FM Radio 211C, XM Radio 211D, and iPod 211E. The source selection wheel 210 is displayed in response to the user choosing the Audio 111D, Control button, and then the Study 131D control button from their respective selection wheels. Control buttons 111D and 131D form a crumb trail along the horizon line 120. As noted elsewhere, the crumb trail tracks the selections (a user makes to reach their current position in the 111D and 131D to reach the AM/FM Radio 211C control button. The focal point in FIG. 2 is the AM/FM Radio 211C control button. Thus, in FIG. 2, the source selection wheel 210 is active and its control buttons are more visible. The room and device selection wheels (110 and 130) are shown grayed out in FIG. 2 to indicate the wheels are inactive.

Audio sources shown in the source selection wheel 210 can be played in any of the rooms listed on the room selection wheel 130. For ease of use and readability, the source selection wheel 210 is preferably displayed adjacent to the room selection wheel 130, left justified, with different shading than the adjacent wheel, in a manner that keeps the user's preferred source control button (AM/FM Radio 211c in FIG. 2) centered on the horizon 120 as the user scrolls from one source to another.

The AM/FM Radio 211C control button, when selected, displays a control panel 220 for the radio as shown in FIG. 2. The control panel 220 provides a subinterface for one or more control buttons and/or selection wheels. FIG. 2's radio control panel 220 comprises volume control, presetting options, dial displays, and station tuning/seek features. For ease of use and readability, control panel 220 is centered horizontally on display screen 100. In FIG. 2, the focal point 150 can be positioned inside the control panel 220 (not shown) to indicate which element is currently under the user's control, and along the horizon 120 of the control panel 220. Control panel 220's station preset selection wheel 222 (listing preset radio stations) preferably appears left justified in the control panel 220, and when possible, it displays all the preset radio stations (222A, 222B, . . . 222N) that have been added by the user. The currently selected radio station preset (100.3), shown slightly larger in size than other preset control buttons, is centered over horizon 120. The station preset selection wheel 222 is implement as a circular, double linked list data structure as described elsewhere. The radio station currently playing (99.1 FM) is shown in AM/FM Radio subpanel 227. The AM Stations 225 and Add Preset 226 control buttons comprise a two element selection wheel, centered over focal point 120. Nudge controls (e.g., Volume 211, Seek 223 and Tune 224) are preferably centered on horizon 120 as well. When a user selects a nudge control, by using the up/down arrows on the remote control point, the system preferably emulates the action on the up or down buttons of the nudge control to raise or lower the value within the control.

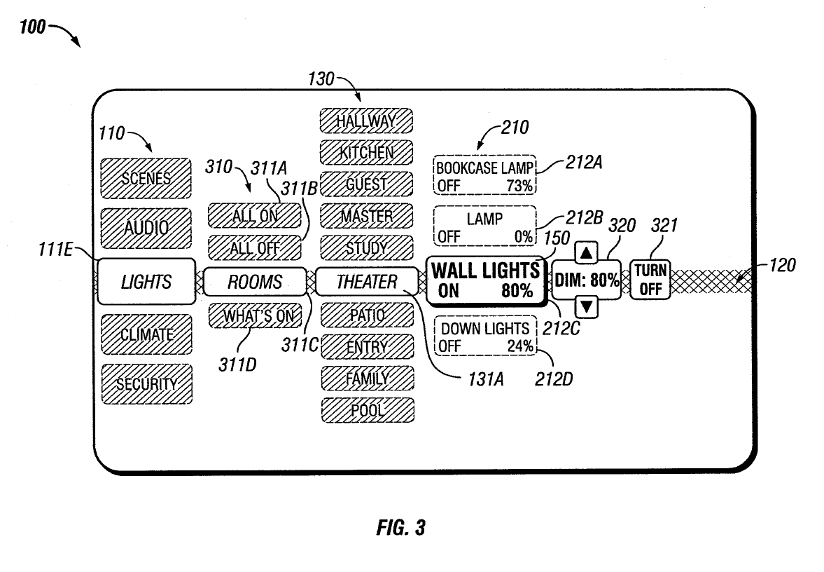

FIG. 3 shows an example control interface for the user to adjust/review light settings in a theater room. The lights 111E control button of device selection wheel 110, when selected, cause the control interface 100 to display utility selection wheel 310. Utility selection wheel 310, shown adjacent to the device selection wheel 110 in FIG. 3, includes the following control buttons: All On 311A, All Off 311B, Rooms 311C, and What's On 311D. The control buttons that are not grayed out (Rooms 311C, Theater 131A, and Lights 115) for a crumb trail that indicates which control buttons have been selected in FIG. 3. The focal point 150 of FIG. 3 is the Wall Lights 212C control button, which the user can adjust/control by navigating to and adjusting the Dim 320 nudge control (currently at 80%) and/or selecting the Turn Off 321 wall lights button.

Although the disclosed embodiments and its advantages have been described in detail, it should be understood that various changes, substitutions and alterations can be made herein without departing from the disclosed embodiments as defined by the appended claims. Moreover, the scope of the present application is not intended to be limited to the particular embodiments of the user interfaces and the methods described in the specification. As one will readily appreciate from the disclosure, user interfaces and methods presently existing or later to be developed that perform substantially the same function or achieve substantially the same result as the corresponding embodiments described herein may be utilized. Accordingly, the appended claims are intended to include within their scope such articles and methods.

What is claimed is:

1. A control interface apparatus for a home automation system comprising:
a selection wheel adapted for display on the control interface;
wherein the selection wheel includes a plurality of control buttons for controlling devices in the home automation system; and
a data structure for linking the selection wheel's control buttons in a continuous ring, so that a complete unidirectional traversal on the selection wheel returns to the control button where the traversal started.

2. The control interface of claim 1, wherein at least one of the selection wheel's control buttons represents a user's current preference and is displayed as a focal point with a different shape and/or shading than other control buttons in the selection wheel.

3. The control interface of claim 2 wherein, for a given control button x in the selection wheel, the data structure further comprises:
a first pointer for indicating the control button x's successor control button; and
a second pointer for indicating the control button x′s predecessor control button;
wherein the first pointer, if control button x is a head control button, indicates a tail control button in the selection wheel; and
wherein the second pointer, if control button x is the tail control button, indicates the head control button in the selection wheel.

4. The control interface of claim 3 further comprising a second selection wheel displayable in a position adjacent to the first selection wheel.

5. A control interface apparatus for a home automation system comprising:
at least one horizon extending from a first edge of the control interface to a second opposite edge; and
at least one focal point for tracking a control button to display along the horizon; wherein the focal point changes from one control button to another as the user navigates the home automation system.

6. The control interface of claim 5, wherein the horizon has a horizontal longitudinal axis that is centered vertically on the control interface.

7. The control interface of claim 6, wherein the focal point tracks the control button under the user's control that, when selected, invokes services on at least one device in the home automation system.

8. A control interface apparatus comprising:
a first selection wheel having a plurality of control buttons displayable as a continuous ring on a control interface; wherein the first selection wheel's control buttons are adapted to for controlling devices in a home automation network; and
at least one horizon on the control interface extending from a first edge of the user interface to a second opposite edge; wherein the horizon provides a centering point for at least one of first selection wheel's control buttons.

9. The control interface of claim 8 further comprising a data structure for linking the selection wheel's control buttons so that a complete unidirectional traversal on the first selection wheel returns to the control button where the traversal started.

10. The control interface claim 9 further comprising at least one focal point adapted for tracking the control button currently under the user's control, wherein the focal point is displayed along the at least one horizon.

11. The control interface of claim 10 further comprising a second selection wheel; wherein the first and second selection wheels are displayed adjacent to one another on the control interface.

12. The control interface of claim 11 further comprising a crumb trail representing at least one control button previously selected by the user.

13. The control interface of claim 12, wherein the at least one control button previously selected is on the first selection wheel and has a different color than the control buttons of the first selection wheel.

14. A method for controlling operations of a home automation system comprising:
displaying a first selection wheel on a control interface of a home automation system;
wherein the first selection wheel includes a plurality of control buttons for controlling devices in the home automation system; and
linking the first selection wheel's control buttons in a data structure so that a complete unidirectional traversal on the first selection wheel returns to the control button where the traversal began.

15. The method of claim 14, wherein the step of displaying a first selection wheel further includes centering a control button representing the control button currently under the user's control along a horizon.

16. The method of claim 15 further including the step of shaping or coloring the focal point differently than the other elements on a display screen.

17. The method of claim 16 wherein, for a given control button x in the first selection wheel, the step of linking the selection wheel's control buttons in a data structure further comprises the steps of:
indicating the control button x's successor control button with a first pointer; and
indicating the control button x's predecessor control button with a second pointer;
wherein the first pointer, if control button x is a head control button, indicates a tail control button in the selection wheel; and
wherein the second pointer, if control button x is the tail control button, indicates the head control button in the selection wheel.

18. The method of claim 17 further comprising the step of displaying a second selection wheel in a position adjacent to the first selection wheel.

19. A method for displaying a control interface on a control point for a home automation system comprising the steps of:
highlighting portion on the control interface to form a horizon that extends from a first edge of the control interface to a second opposite edge;
tracking a user's current preference on the control interface with at least one focal point as the user navigates the home automation system; and
displaying the focal point along the horizon.

20. The method of claim 19, wherein the step of highlighting further includes the steps of:
displaying the horizon along the longitudinal axis of the control interface, and centering the horizon vertically on the control interface.

21. The method of claim 19, wherein the step of displaying further comprises centering and re-centering focal point on the horizon as the user navigates.

22. The method of claim 22 wherein the step of displaying further comprises coloring the focal point differently than other elements on the control interface.

23. A method for displaying a control interface on a control point for a home automation system comprising the steps of:
providing at least one selectable control button positioned along a vertical access of a display screen on a control point;
providing at least one command control button for invoking services of a device in a home automation system; wherein the at least one command control button is centered displayed a horizontal access of the display screen on a control point; and
wherein the at least one selectable control button and at least one command control button are displayed as part of a selection wheel.
